(19) United States
(12) Patent Application Publication
(10) Pub. No.: US 2006/0051509 A1
(43) Pub. Date: Mar. 9, 2006

(54) Process and equipment for uniform coating medium of treatment on materials in the form of rope

(75) Inventors: Carl Cordes, Schwabish Hill (DE); Thomas Widmer, Luzern (CH); Lee Che Keung, Hong Kong (CN)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: THEN MASCHINEN (B.V.I.)LIMITED, Tortola (VG)

(21) Appl. No.: 10/967,312

(22) Filed: Oct. 19, 2004

(30) Foreign Application Priority Data
Oct. 21, 2003 (DE) 103 49 377.8-26

(51) Int. Cl. B05D 1/40; B05C 11/00; D06B 3/28; D06P 5/00

(52) U.S. Cl. 427/345; 427/430.1; 118/665; 8/400

(57) ABSTRACT

In a process and a device i.e., an equipment, meant for uniform coating of a medium of treatment on a rope-material inside a closed chamber, the rope-material which is located inside a container and which is in the form of a (closed) loop is set in circular motion by means of a venturi-type nozzle, on which a gaseous transport medium impinges. In the process, the rope-material is exposed to a liquid medium of treatment which is stored in a separate chamber without coming in contact with the rope-material. The medium of treatment is coated on the running rope-material from this chamber. The coating of the rope-material is controlled in a time-dependent manner for a unit of time.

This invention deals with a process and equipment meant for uniform coating of medium of treatment i.e., agency used as treatment on materials on goods/materials that exist in the form of a rope. This is done in a dyeing or colouring machine.

Nozzle type piece-dyeing machines have a closed container and a nozzle system, through which a rope formed as a loop and found in the container, is set in circular motion in the prescribed direction of rotation, and this is supported by a separately driven roller. To drive the rope, a stream of transport medium/agency creates an impact or pressure in the nozzle and the stream is normally a treatment bath, or a stream of gas, air, steam or air-steam mix, which usually work according to the principles of aerodynamics.

In this type of dyeing/colouring machine, the treatment bath is fed into that section of the machine where the nozzle is, and it is applied on the through-running loop type rope. The excess treatment bath that flows out is collected in a container and recycled by means of a main pump.

In the case of all these dyeing or colouring machines, the medium of treatment that is to be coated on a material (chemicals and/or dyestuff) is filled up initially in a separate container available as an attachment. And in certain cases it is mixed and, if necessary also brought to a particular temperature and subsequently fed into the circulating bath by means of a reagent pump. Usually, the medium of treatment is also fed-in at this juncture. It means that at a particular point of time during the moistening process the medium of treatment held in the additional (separate) container is injected into nozzle in the form of fine powder, and thus coated on the rope material.

If the process of treatment is more closely observed, it would become evident that, the concentration of coating increases from one circular motion to the next, and at the same time the concentration of medium of treatment at the beginning of the rope is lower than what it is at the end of the rope. If, e.g., the coating is applied over five cycles of the rope motion, it is possible that at the end of the rope in the fifth cycle a higher concentration of the material, which is more than the eventual balanced coating, is likely to be found. The balanced and thus uniform coating will be achieved only after further cycles of the rope.

That, a uniform treatment of the medium or rather a uniform distribution of the dye stuff takes place over the entire length of the rope, is an essential pre-requisite for treating the rope with a medium of treatment, and especially for dyeing it. Only in that case, one can reckon with the most uniform and even coating of the dye stuff. Hence, the task of this process is to create or get as far as possible a uniform distribution of the medium of treatment on a rope-material that is set in circulating motion in a wet-process machine.

In order to achieve this task, the process pertaining to this invention incorporates those features given in the patent claim 1.

In the new process, a rope in the form of a loop, placed in a closed container, is set in circulating motion, i.e., rotary motion by a venturi nozzle and a gaseous matter impinges on the venturi type nozzle. The circular i.e., rotary motion of the rope-material is maintained only by means of the gaseous transporting medium, and not by the bath. In the first place, the medium of treatment is stored in a separate chamber, and it does not come in contact with the rope-material. This, e.g., is a chamber found below the one which holds the rope-material, and in the whole container it acts as a sump or a basin for the medium of treatment. All the necessary chemicals and dye-stuff etc. are accommodated in this basin or sump. The liquid medium used for treatment and stored in this container i.e., the treatment bath, can be brought to a pre-determined temperature and also pre-mixed via a corresponding injection cycle circuit for the medium of treatment and this is achieved without the medium coming in contact with the goods i.e., rope. This chamber can also be provided outside the container, say, e.g., as a self-contained vessel.

In the next step of this process of treatment, the medium of treatment that is available as a fresh treatment-bath is coated on the running rope. And the quantity of such a coating is so regulated per unit of time that the medium (i.e., the medium of treatment that is coated) is distributed over the rope in a uniform manner.

This coating of the material on the rope can be done in one or more number of rotary cycles of the rope material. By employing a measured regulation and control of the injection of the treatment material, a uniform coating can be achieved within a few rotary cycles of the rope (e.g., within 2 or 3 cycles) or it is even possible to achieve this within one circular motion (rotary cycle).

The course of progress to be attained in coating in terms of time-measure can be computed in a mathematical model (computer program)) in advance. And in such a case the coating of the material on the rope is done in a regulated manner as per this mathematical model. The pre-computation. of the coating on the rope in the mathematical model i.e., computer program, is based on the various data on material, design and treatment of the rope and/or the nozzle as well as the impact or impingement of the medium of transport. These data can be fed by the user into the computer which is programmed according to the mathematical model. Or alternatively, it can be automatically acquired (as data) by the corresponding sensors in the machine. Taking into account the respective parameters and the mathematical model, the computer itself calculates and arrives at a time-dependent coating parameter of the medium of treatment on the moving rope-material, thus achieving an optimum distribution of coating over the length of the rope within as low a cycle (i.e., no. of circular motions) as possible.

The advantage of this process is that it enables a faster and a more uniform distribution of the medium of treatment over the entire rope, whereby the necessary pre-requisite for uniform dyeing is created. That apart, the time taken for such a treatment is considerably reduced, as the coating of the medium of treatment takes place within considerably lesser number of cycles, which is very much lower than the usually known process described in the beginning.

Further developments of the invention are the objects of the subordinate claims, and can be derived from the following description of the process concerning this invention, which is shown in the attached drawing. The drawing shows the following figures.

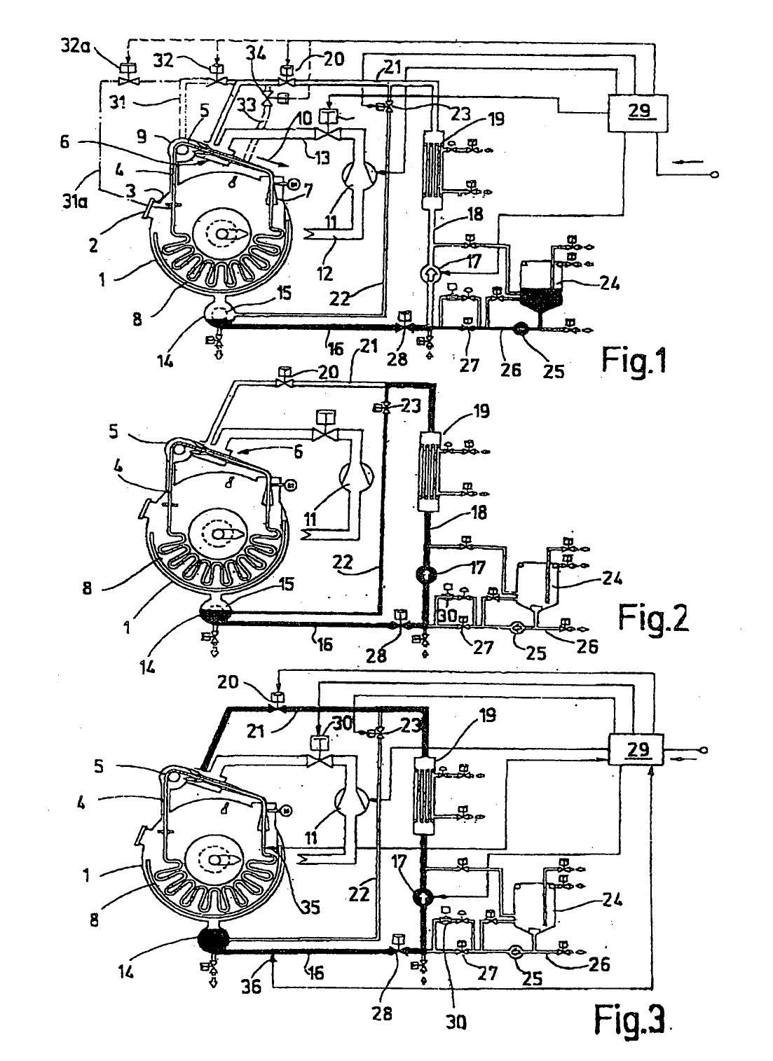

FIG. 1 A piece dyeing machine working on aerodynamic principle, showing a schematic projection of the cross-section, illustrating the condition present while the material is pumped in from the dosing tank found in the basin or sump of the dyeing machine.

FIG. 2 The piece dyeing machine of FIG. 1 in a correspondingly simplified representation, illustrating the condition obtaining while the material is being mixed and tempered.

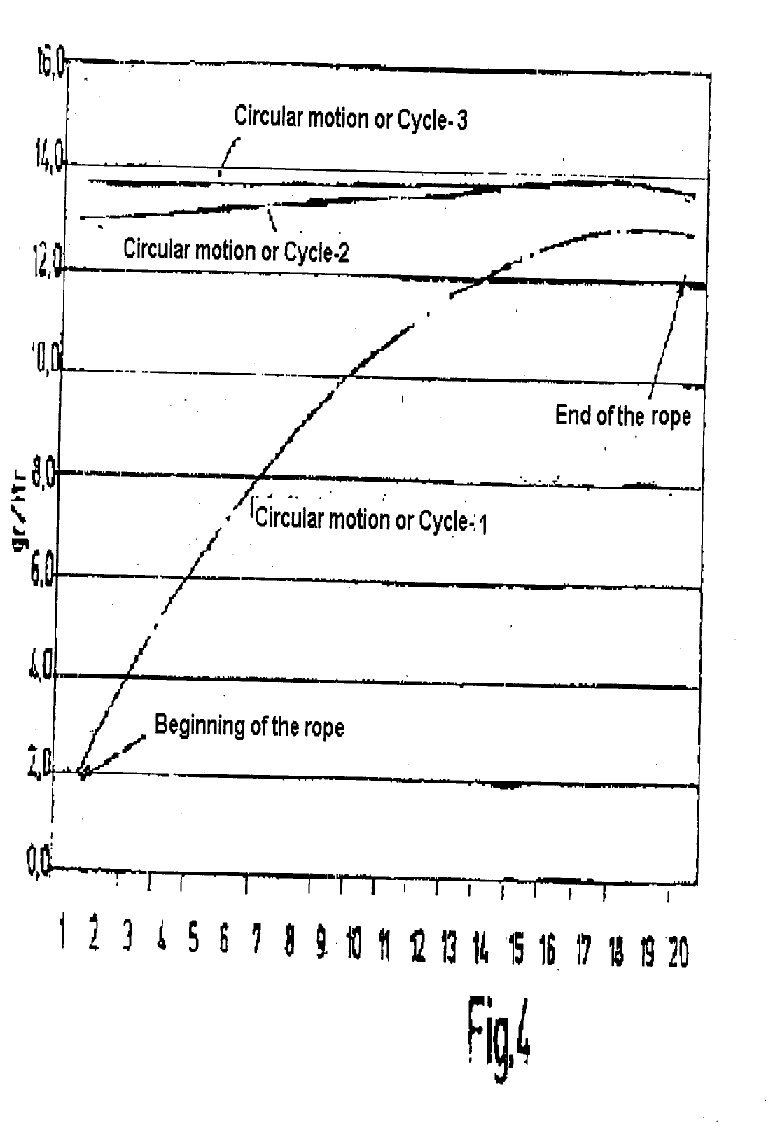

FIG. 3 The piece-dyeing machine as per FIG. 1 in a correspondingly simplified representation, illustrating the condition obtaining while the medium/material of treatment is being injected into the venturi-type nozzle.

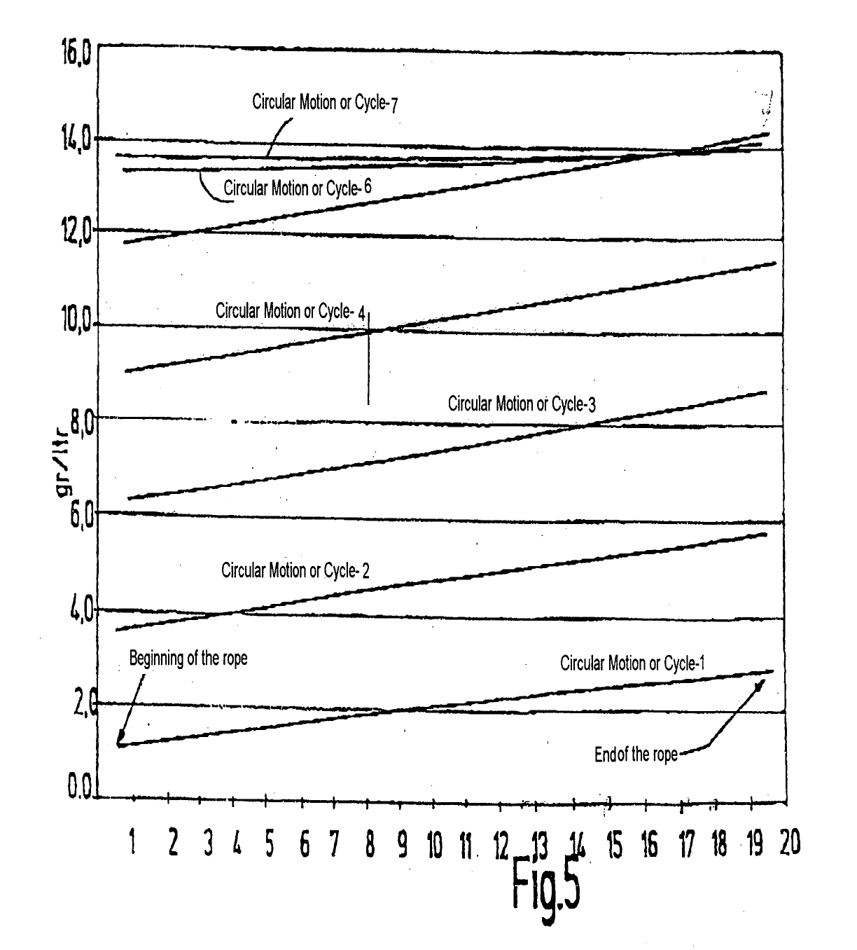

FIG. 4 A diagram to illustrate the coating of the dye stuff on the rope in a piece dyeing machine as per FIGS. 1 to 3 while making use of the process described in this invention. &

FIG. 5 A diagram as per FIG. 4 illustrating the coating of the dye stuff on the rope-material by making use of the process already known.

The high temperature piece dyeing machine schematically shown in FIGS. 1 to 3 has a pressure resistant cylindrical container 1, in which there is an opening 3 provided for operational purposes that can be closed by a cover or lid 2; and through this opening the rope material 4 can be introduced. The rope material 4 is introduced into the venturi type nozzle 6 by means of a roller 5 having an independent drive. The venturi type nozzle is connected to a plaiting device 7. The plaiting device 7 lays the rope material 4 in a storing chamber 8 from which the rope is again drawn out by means of roller 5. The roller 5 and the transporting nozzle 6 are located in the housing section 9 which is connected with the container 1 in a watertight (waterproof manner. The ends of the rope material 4 were connected to one another to form a closed loop, after their having been introduced through the opening 3 provided for working.

A gaseous-stream acting as transporting medium impinges on the nozzle 6 and this stream of gas sets the rope-material 4 in circular motion in the direction shown by the arrow 10. In this case, discussed herein, the medium of transport is either gas or a mixture of steam and air. It is sucked in by a (suction) blower 11 and a suction pipe 12 from container 1 and is fed into the nozzle 6 via a high-pressure delivery pipe.

At the bottom of the container 1 there is a basin or sump and it has a sieve 15 for the bath. The bath-sump 14 is connected to a suction pipe 16 of a main pump 17, whose discharge pipe contains a heat exchanger 19, and the discharge pipe itself is joined with the nozzle 6 via a check valve (control valve) 20. The main pump 17 enables the circulation of the bath sucked from container 1, and fed via its bath sump to circulate through the nozzle 6 and the container 1. Parallel to the heat exchanger 19 and the main pump 17 there runs a by-pass pipe 22 which has a shut-off valve 23 and connects the sump 14 with the discharge pipe 21 which is again connected to the heat exchanger.

Finally, there is yet another dosing tank 24 which contains the medium of treatment—the chemical—in a liquid solution, emulsion or dispersion (chemicals, dye-stuff etc.) which can be fed into the suction pipe 16 of the main pump 17 via a dosing pump 25 meant for the medium of treatment, and via the connecting pipe 26.

The piece dyeing machine described so far works on aerodynamic principle and it is well known by itself. In order to give a uniform coating of the medium of treatment on the rope-material 4 that is in circular motion, the following process is adopted as per the invention.

A liquid medium of treatment, which contains all the additives necessary for wet processing (such as chemicals, dye-stuff etc.) is fed into the dosing tank 24. The container 1 is empty. The rope material can be either at rest or, driven by the stream of transport blown by the fan/blower 11 it can be in circular motion.

In the first step (of treatment) illustrated in FIG. 1, the medium of treatment put into the dosing tank 24 is fed into the basin or sump 14 of container 1 with all its additives, by means of the dosing pump 25 meant for delivering the medium of treatment. The main pump 17 is at rest, and the shut-off valve is opened. Evidently, the feeding of the medium of treatment into the basin/sump 14 takes place without any contact with the rope-material 4, for herein the medium of treatment is held in the basin (sump) 14 (shown in darker shade in FIG. 1) and remains below the storage chamber 8 and hence it does not come in contact with the rope-material 4.

After the medium of treatment is fed into the basin/sump 14 it is made to circulate along the circulation path shown in darker shade in FIG. 2. It is circulated by means of the circulating pump 17 and thereby thoroughly mixed. And simultaneously, it is brought to the desired temperature in the heat exchanger 19. As is evident, the circulation takes place via the by-pass pipe 22 and the basin/sump 14 besides the bath-circulating pump 17 and the heat exchanger 19. The shut-off valves 23 & 28 are opened. The dosing pump 25 meant for medium of treatment is at rest and is blocked on the high-pressure side by the shut-off valve 27. The medium of treatment, which is now brought in circulation along its assigned path, still does not come in contact with the rope-material 4.

In the third step (of treatment), the shut-off valve 23 is closed from now on, the main pump 15 sucks the medium of treatment that has by now been thoroughly mixed from the basin/sump 14 and pumps it via the discharge pipe 21 into the nozzle 14, where it is coated on the rope-material. The excess coating material that runs off, flows into the sump/basin 14 and is again sucked by the main pump 15.

The coating of the medium of treatment on the rope-material 4 is controlled by a computer 29 which senses the parameters on the bath-circulating pump 15 and/or the check valve 20 in the discharge pipe 21 and /or the fan/blower 11 or the butterfly valve 30 in the discharge pipe 13. The computer 29 is programmed with a mathematical model, which were computed/calculated as per parameters/data specific to the material, and/or specific to design the factors, and/or specific to treatment of the rope-material 4 or rather the nozzle 6. Among other things, data/parameter specific to the material are weight, substrate and finish of the rope-material 4. The maximum amount of liquid—in litre—that would be absorbed by the rope-material per metre is computed from that. The quantity of the liquid that is actually absorbed—when computed—as a proportion of the weight of the rope-material gives out the so called Pick-Up A, which is considered to be a characteristic data. Among other things, data such as dimensions of the nozzle, length of the nozzle, dimensions of the annular gap and the like are considered to be design-specific data. The speed of circular motion of the rope-material 4, the temperature of the medium of treatment and its proximity to the material, the extent of moisture-loading exerted on the rope-material at the time of entry into the nozzle 6 etc., are taken to be—among other things—data relevant to be treatment-specific. The amount of medium of treatment coated on the running rope-material 4, in the nozzle in a unit of time is so controlled by the computer 29 that, primarily a uniform distribution of the material i.e., medium of treatment is achieved on the rope-material 4. Depending on the programming of the computer and from the data fed in as input by the user, an optimal distribution of the material coating takes place on the rope-material 4. The coating of the material, i.e., medium of treatment can take place within one or more number of circular-motion of the rope-material.

FIG. 4 illustrates an example of the type or execution, in order to present a clear picture of the process dealt with in this invention. The medium of treatment (i.e., dye stuff) coated on the rope-material in gram per litre, in relation to the length of the rope-material is shown here. The example taken as the basis in FIG. 4 is based on the coating done within one cycle (circular movement) of the rope-material for a fresh material taken out of the basin/sump 14. It is however seen, that in the first cycle i.e., circular motion of the rope-material, the difference in concentration between the beginning of the rope and its end is relatively high. But the difference in concentration between the beginning and the end of the cycle is considerably lesser, in the second cycle itself. Hence, a very good uniformity in coating is achieved over the entire length of the rope, even in this cycle. In the third cycle (circular motion) of the rope-material (shown in dotted line) a near uniform distribution of the coating material is achieved over the length of the rope. In the second and the third cycles (circular motion) of the rope-material, the medium of treatment coated on the rope-material 4, comprises material, which is a mix of material that has dripped off the previous cycle of the rope 4 and got collected in the basin/sump 14 and which in turn has got mixed with the material that is still left in the basin/sump 14.

Experiments have shown that, basically, it is possible to program the computer 29 in such a manner, that it regulates the dosing of the coating of treatment-medium per unit of time, so that the desired uniform distribution of the medium of treatment can be achieved even within one cycle of rotation of the rope-material. However, in the scheme shown in FIG. 4, it is accomplished only in the third cycle i.e., the third circular motion.

In order to compare the new process with the state-of-the-art technology, a graph that corresponds to FIG. 4 is shown in FIG. 5. It represents the coating of the medium of treatment (i.e., dye stuff) on the rope-material 4 that is in motion, wherein the present day process is made use of. In this process, the medium (material) of treatment available in the dosing tank 24 is dosed into the suction pipe 16 of the main pump 17 via a dosing throttle shown in 30. And it is done in such a manner that the quantity of treatment material held in the dosing tank 24, is fed into the injection circulation pipe of the dyeing (colouring) machine within a pre-determined period of time. However, it can be deduced from FIG. 5 that the concentration of medium of treatment on rope-material 4 increases from one cycle of the rope to the next, wherein the concentration of coating at the beginning of the rope is also lesser than what it is at the end. In the fifth cycle of circular motion of the rope-material, there arises at the end of the rope a higher level of concentration of the medium of treatment, which would be more than the equilibrium of concentration to be attained. Only after seven cycles of circulating motion of the rope-material, the equilibrium of concentration is achieved in this example (cycle-7).

In the new process, the speed of circular motion of the rope-material 4 can be varied by means of the computer, while the medium of treatment is being coated on the rope-material 4. But it can also be maintained at a constant speed. As practical experiments have shown, just a few cycles (circulating motions) are enough for coating the medium of treatment. As a rule it is considerably less than five cycles. As already mentioned, the medium of treatment can be coated on the rope-material, even within one cycle, when the computer 29 is suitably programmed.

In the case of the execution (or the type) discussed herein, the medium of treatment is injected into the nozzle 6 (FIG. 3) and thereby coated on the rope-material 4.

Alternatively or additionally, the new process can be designed in such a manner that the medium of treatment can be coated on the rope-material either before and/or after the nozzle 6, along the path travelled by the rope-material. This is illustrated schematically as an example in FIG. 1. A pipe 31 meant for the medium of treatment, which branches off a discharge pipe 21 joins with the housing 9 above the roller 5, which has a check valve (control valve) that can be regulated by the computer 29.

Thereby, the rope-material entering the nozzle 6 is already loaded/coated with the medium of treatment. The pipe 31 need not necessarily have to join in this area or section through the roller 5. Depending on the given conditions, the joining of the pipe 31 can be anywhere between the roller 5 and the nozzle orifice of the venturi type nozzle 6. Besides this, it is also possible to design various other types, in which, the joining of the pipe 31 is located in the (vertical) path of travel of the rope-material 4, that lies between the storage(bin) 8 and the roller 5, and the medium of treatment is already coated before it i.e., the rope-material 4 reaches the roller 5.

FIG. 1 shows this variation in a dotted line, which has a discharge pipe 31a in which there is a control valve 32a which can be controlled by the computer 29.

Besides this, a discharge pipe 33 joining behind the nozzle 6 can be provided, which e.g., branches off the discharge pipe 21 and which also has a control valve 34, and which will again be controlled by the computer 29. It is possible in this manner to coat the medium of treatment on the rope-material 4, after the nozzle 6 either alternatively or additionally.

The coating of the medium of treatment on rope-material 4 is controlled by the computer 29. But it can also be regulated on the basis of the data that is characteristic to coating the medium of treatment on the moving rope-material 4, and this (the data) can be acquired during the course of the coating process. These data are processed by the computer 29 within the framework of its main or control program in which process it makes use of the mathematical model on which the control program is based. Suitable sensors are provided for this purpose, and they are shown as 35 & 36 in FIG. 3. And of these sensors 35 directly monitors the rope-material 4 and the sensor 36 monitors the medium of treatment. The parameters thus monitored can be factors like, the pH-value, concentration of dye-stuff (how diluted it is) in the medium of treatment etc., but they can also be factors pertaining to the rope-material that can be sensed optically or otherwise.

1. Process for uniform coating of a medium used for treatment on ropes (used as goods) by means of a dyeing apparatus in which the following process takes place
the rope in the form of a loop is set in circular motion by a venturi type nozzle, in a closed container and the a gaseous transport medium impinges on the nozzle
and thus the rope is subjected to the effect produced by a liquid medium of treatment characterized in that,
the medium of treatment is fed into a separate chamber without coming in contact with the rope to be treated, and the medium of treatment i.e., the agency which gives this treatment is coated on the moving rope in a regulated quantity, which is time-dependant and is fixed for a unit of time.

2. The process as per claim 1 is characterized by the fact that the quantity of treatment material thus coated per unit of time is regulated according to the speed of circulation or movement of the rope.

3. The process as per claim 1 is characterized by the fact that the speed of circular motion of the rope during this coating process is kept constant.

4. The process as per claim 2 is characterized by the fact that the speed of circular motion of the rope during this coating process is varied.

5. As per claim 1, the process is characterized by the fact that the coating of the medium on the rope takes place in less than five circular motions of the rope.

6. The process as per claim 1 is characterized by the fact that the medium of treatment is coated within just one and only circular motion of the rope.

7. The process as per claim 1 is characterized by the fact that the medium of treatment is rolled or circulated within one and only chamber or space of the container.

8. The process as per claim 1 one of is characterized by the fact that the medium used for treatment is brought to a predetermined temperature before its being coated on a rope.

9. The process as per claim 1 is characterized by the fact that the medium of treatment is coated on the rope from a separate chamber or space and it is pumped by a pump in the same direction as that of the motion of the rope; and the pumping is done either at the transport-nozzle or after or before it, or it is conveyed along with stream that causes the motion or transport.

10. The process as per claim 9 is characterized by the fact that the regulation of the quantity of coating attained per unit of time is achieved by the regulation of the pumping medium and or by adjusting the valves meant for such a task.

11. The process as per claim 1 is characterized by the fact that, the medium of treatment is stored in a chamber, that lies below the chamber in which the rope-material is placed thus forming a basin/sump for the medium of treatment in the container.

12. The process as per claim 1 is characterized by the fact that, the excess medium of treatment that overflows during the coating on the rope-material is fed back to the separate chamber.

13. The process as per claim 1 aims is characterized by the fact that, the factor reckoned for the passage of time for coating the medium of treatment on the rope-material is computed in advance in a mathematical model, and the coating of the medium of treatment on the rope-material is done in a manner controlled/regulated as per this mathematical model.

14. The process as per claim 13 is characterized by the fact that, the computation/calculation (in advance) of the mathematical model is based on material-specific and treatment-specific data of the rope-material and/or data specific to the design of the nozzle and (finally) also the factor of impingement taking place with the medium of treatment.

15. The process as per claim 1 is characterized by the fact that, the coating of the medium of treatment on the rope is regulated on the basis of material-specific and/or treatment-specific data and these data are collected by sensors during the process of coating

16. The device for conducting the process as per claim 1 has a closed container (1) and a venturi type transport-nozzle-system (6) attached to the container, on which (i.e., the nozzle) a gaseous medium of transport impinges, and it is provided with an equipment for coating a liquid medium of treatment on a running rope-material (4) which is set in circular motion by means of the nozzle-system (6) located in the container (1), characterized in that
it has an isolated chamber (14) for holding the medium of treatment, and an equipment (17 & 23) for circulating the medium of treatment held in that chamber (14) besides which, it also has a regulating or controlling system (29) which enables the regulation of the coating of the medium of treatment kept in chamber (14) on to the rope-material (4) in a time-dependent manner for a unit of time.

17. The device or equipment as per claim 16 is characterized by the fact that, the circulating equipment, which circulates the medium of treatment, incorporates a heat exchanger (19).

18. The device or equipment as per claim 16 is characterized by the fact that it has equipment (31, 32, 31a, 32a, 20, 21, 33, 34 & 17) for coating the medium of treatment at or after the transport-nozzle-system (6) or in the path of the medium of transport.

19. The device or equipment as per claim 16 is characterized by the fact that, it i.e., the device or equipment has sensors (35 & 36) which monitor the rope-material and/or the medium of treatment, and i.e., the sensors feed the characteristic data necessary for coating the medium of treatment on the rope-material into the controllers (regulating system) (29) during the coating process, and the controllers or the regulators (29) are equipped to process such data according to the program.
